(19) United States
(12) Patent Application Publication
(10) Pub. No.: US 2014/0345741 A1
(43) Pub. Date: Nov. 27, 2014

(54) FLEXIBLE PIPE BODY AND METHOD OF MANUFACTURE

(71) Applicant: Wellstream International Limited, Tyne and Wear (GB)

(72) Inventor: Geoffrey Stephen Graham, Tyne and Wear (GB)

(73) Assignee: Wellstream International Limited, Tyne and Wear (GB)

(21) Appl. No.: 14/368,405

(22) PCT Filed: Dec. 12, 2012
(86) PCT No.: PCT/GB2012/053107

§ 371 Date: Jun. 24, 2014

(30) Foreign Application Priority Data
Dec. 29, 2011 (GB) 1122437.5

(51) Int. Cl. F16L 11/00

(52) U.S. Cl. CPC F16L 11/00
USPC 138/137; 29/428

(57) ABSTRACT

A flexible pipe body (400) and method of producing a flexible pipe body are disclosed. The flexible pipe body (400) includes a collapse resistant layer (404); and a fluid retaining layer (406) provided radially outwards of the collapse resistant layer (404), wherein the collapse resistant layer (404) comprises at least one elongate band of material having a cross-sectional profile having a fill factor of between 60 and 95%.

The present invention relates to a flexible pipe body and a method of manufacture. In particular, but not exclusively, the present invention relates to a flexible pipe body having a collapse resistant layer with improved performance compared to known designs.

Traditionally flexible pipe is utilised to transport production fluids, such as oil and/or gas and/or water, from one location to another. Flexible pipe is particularly useful in connecting a sub-sea location (which may be deep underwater, say 1000 metres or more) to a sea level location. The pipe may have an internal diameter of typically up to around 0.6 metres. Flexible pipe is generally formed as an assembly of a flexible pipe body and one or more end fittings. The pipe body is typically formed as a combination of layered materials that form a pressure-containing conduit. The pipe structure allows large deflections without causing bending stresses that impair the pipe's functionality over its lifetime. The pipe body is generally built up as a combined structure including metallic and polymer layers.

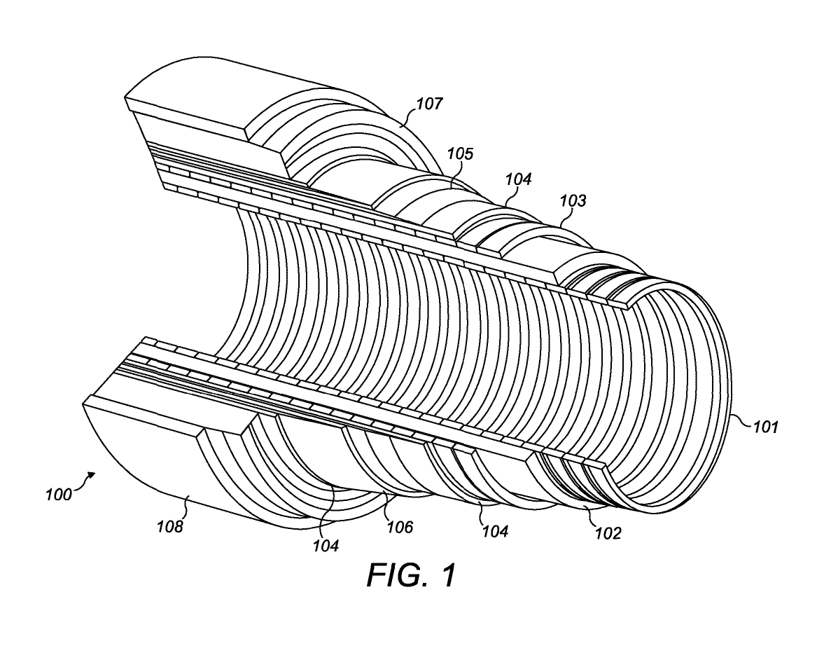

Throughout this description, reference will be made to a flexible pipe. It will be understood that a flexible pipe is an assembly of a portion of a pipe body and one or more end fittings in each of which a respective end of the pipe body is terminated. FIG. 1 illustrates how pipe body 100 may be formed from a combination of layered materials that form a pressure-containing conduit. Although a number of particular layers are illustrated in FIG. 1, it is to be understood that the present invention is broadly applicable to coaxial pipe body structures including two or more layers manufactured from a variety of possible materials. The layer thicknesses are shown for illustrative purposes only.

As illustrated in FIG. 1, a pipe body includes an optional innermost carcass layer 101. The carcass provides an interlocked construction that can be used as the innermost layer to prevent, totally or partially, collapse of an internal pressure sheath 102 due to pipe decompression, external pressure, and tensile armour pressure and mechanical crushing loads.

The internal pressure sheath 102 acts as a fluid retaining layer and comprises a polymer layer that ensures internal fluid integrity. It is to be understood that this layer may itself comprise a number of sub-layers. It will be appreciated that when the optional carcass layer is utilised the internal pressure sheath is often referred to by those skilled in the art as a barrier layer. In operation without such a carcass (so-called smooth bore operation) the internal pressure sheath may be referred to as a liner.

An optional pressure armour layer 103 is a structural layer with a lay angle close to 90° that increases the resistance of the flexible pipe to internal and external pressure and mechanical crushing loads. The layer also structurally supports the internal pressure sheath, and typically consists of an interlocked construction.

The flexible pipe body also includes an optional first tensile armour layer 105 and optional second tensile armour layer 106. Each tensile armour layer is a structural layer with a lay angle typically between 10° and 55°. Each layer is used to sustain tensile loads and internal pressure. The tensile armour layers are often counter-wound in pairs.

The flexible pipe body shown also includes optional layers of tape 104 which help contain underlying layers and to some extent prevent abrasion between adjacent layers.

The flexible pipe body also typically includes optional layers of insulation 107 and an outer sheath 108, which comprises a polymer layer used to protect the pipe against penetration of seawater and other external environments, corrosion, abrasion and mechanical damage.

Each flexible pipe comprises at least one portion, sometimes referred to as a segment or section of pipe body 100 together with an end fitting located at at least one end of the flexible pipe. An end fitting provides a mechanical device which forms the transition between the flexible pipe body and a connector. The different pipe layers as shown, for example, in FIG. 1 are terminated in the end fitting in such a way as to transfer the load between the flexible pipe and the connector.

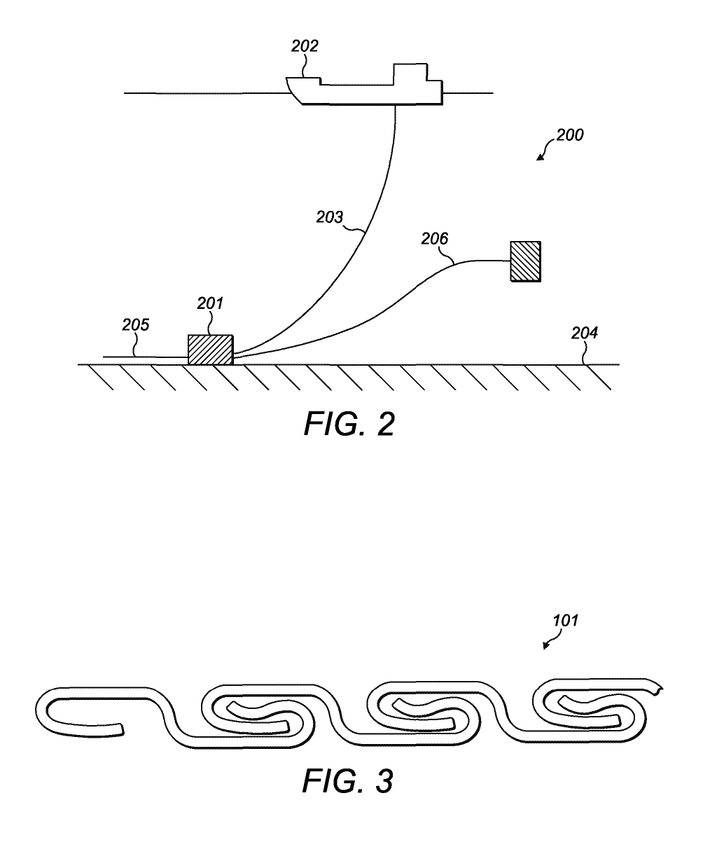

FIG. 2 illustrates a riser assembly 200 suitable for transporting production fluid such as oil and/or gas and/or water from a sub-sea location 201 to a floating facility 202. For example, in FIG. 2 the sub-sea location 201 includes a sub-sea flow line. The flexible flow line 205 comprises a flexible pipe, wholly or in part, resting on the sea floor 204 or buried below the sea floor and used in a static application. The floating facility may be provided by a platform and/or buoy or, as illustrated in FIG. 2, a ship. The riser assembly 200 is provided as a flexible riser, that is to say a flexible pipe 203 connecting the ship to the sea floor installation. The flexible pipe may be in segments of flexible pipe body with connecting end fittings.

It will be appreciated that there are different types of riser, as is well-known by those skilled in the art. Embodiments of the present invention may be used with any type of riser, such as a freely suspended (free, catenary riser), a riser restrained to some extent (buoys, chains), totally restrained riser or enclosed in a tube (I or J tubes).

FIG. 2 also illustrates how portions of flexible pipe can be utilised as a flow line 205 or jumper 206.

Unbonded flexible pipe has been used for deep water (less than 3,300 feet (1,005.84 metres)) and ultra deep water (greater than 3,300 feet) developments. It is the increasing demand for oil which is causing exploration to occur at greater and greater depths where environmental factors are more extreme. For example in such deep and ultra-deep water environments ocean floor temperature increases the risk of production fluids cooling to a temperature that may lead to pipe blockage. Increased depths also increase the pressure associated with the environment in which the flexible pipe must operate. As a result the need for high levels of performance from the layers of the flexible pipe body is increased.

Flexible pipe may also be used for shallow water applications (for example less than around 500 metres depth) or even for shore (overland) applications.

As mentioned above, rough bore and smooth bore flexible pipes are known. Smooth bore flexible pipe includes a fluid retaining layer called a liner. A smooth inner surface of the liner defines a bore along which fluid is transported. Smooth bore flexible pipes are used in various applications, such as for water injection, or for shallow water applications. However, on occasion when a bore is depressurised an accumulated pressure in an annulus region of the flexible pipe between the liner and a radially outer layer can cause the liner to collapse and this leads to irreversible damage. Therefore in some applications where collapse resistance is important, a carcass layer is used inside the fluid retaining layer. This is a so-called rough bore application and the carcass layer, which is often formed by helically winding shaped strips in an interlocked fashion as shown in cross section in FIG. 3, prevents collapse of the fluid retaining layer under depressurisation of the bore by supporting the fluid retaining layer.

Known carcass layers generally give a less smooth finish to the inner surface of the pipe body, which can adversely affect fluid flow through the pipe.

US2006/0130924 discloses a flexible pipe including a carcass covered with an anti-turbulence sheath. However, the sheath may still allow vortices in the fluid flow though the bore.

According to a first aspect of the present invention there is provided a flexible pipe body, comprising:
a collapse resistant layer; and
a fluid retaining layer provided radially outwards of the collapse resistant layer,
   wherein the collapse resistant layer comprises an elongate band of material having a cross-sectional profile having a fill factor of between 60 and 95%.

According to a second aspect of the present invention there is provided a method of manufacturing a flexible pipe body, comprising:
providing a collapse resistant layer; and
providing a fluid retaining layer provided radially outwards of the collapse resistant layer;
   wherein the collapse resistant layer comprises an elongate band of material having a cross-sectional profile having a fill factor of between 60 and 95%.

Certain embodiments of the invention provide the advantage that a carcass-type layer of a flexible pipe body can be provided that has improved collapse resistance compared to known carcass layers.

Certain embodiments of the invention provide the advantage that a flexible pipe body is provided that has great collapse resistance, yet acts as a smooth bore type of pipe with a smooth radially innermost layer.

Certain embodiments of the invention provide the advantage that an improved flexible pipe body is provided using known techniques and equipment in a new way.

Embodiments of the invention are further described hereinafter with reference to the accompanying drawings, in which:

FIG. 1 illustrates a flexible pipe body;

FIG. 2 illustrates a riser assembly;

FIG. 3 illustrates a cross sectional view of a known carcass layer;

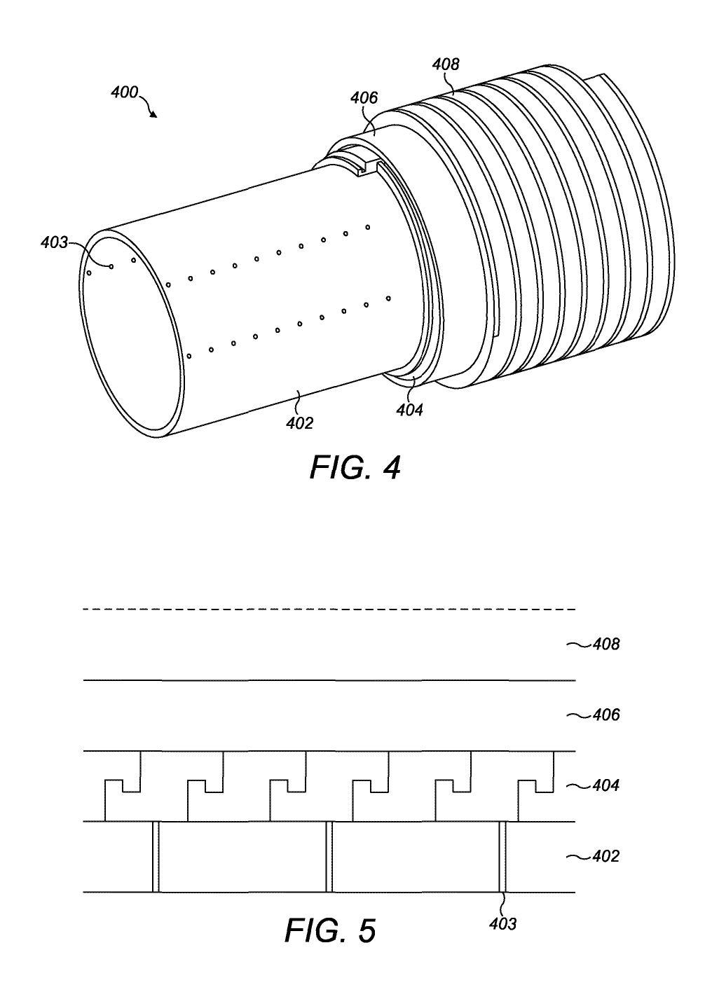

FIG. 4 illustrates a flexible pipe body according to an embodiment of the invention;

FIG. 5 illustrates a cross section of the pipe body of FIG. 4;

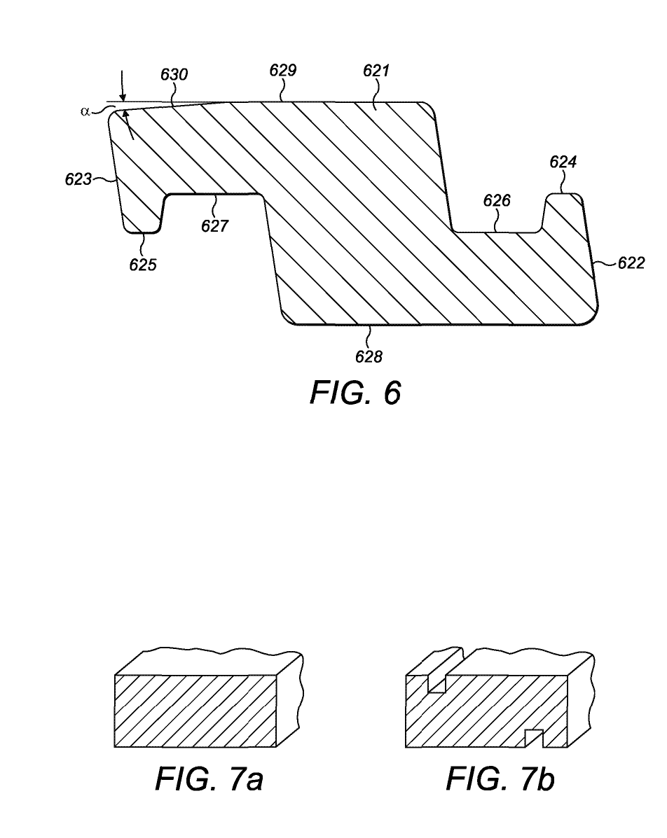

FIG. 6 illustrates a cross sectional profile of a winding of a collapse resistant layer;

FIG. 7a illustrates a band with 100% fill factor;

FIG. 7b illustrates a band with less than 100% fill factor;

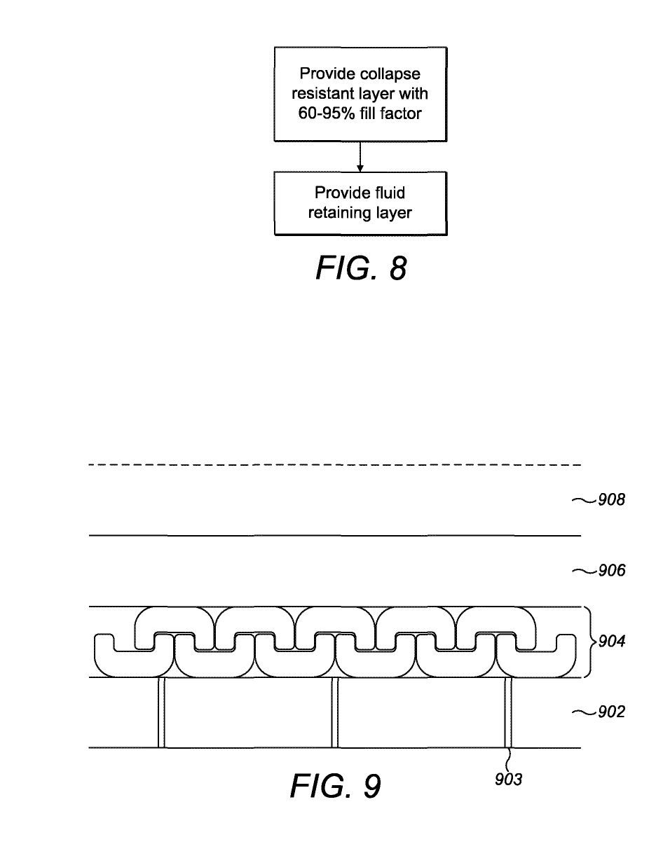

FIG. 8 illustrates a method of the present invention; and

FIG. 9 illustrates an alternative cross section of a pipe body.

In the drawings like reference numerals refer to like parts.

FIGS. 4 and 5 illustrate a flexible pipe body 400 according to the present invention. The pipe body 400 is formed of overlying generally cylindrical layers, including an innermost supporting layer 402 of thermoplastic polymer for forming a substantially smooth inner surface for facing the bore fluid in use. The supporting layer 402 has a plurality of perforations 403 extending therethrough from the bore facing surface to the radially outer surface. The number and layout of the perforations can be determined by a person skilled in the art. For example, the perforations may be around 5 mm in diameter and spaced by around 20 mm and may be mechanically pierced into the layer 402 after extrusion. The supporting layer 402 has a thickness of between around 4 and 15 mm.

Provided over the supporting layer 402 is a collapse resistant layer 404. The collapse resistant layer 404 is formed from an elongate metal band that is helically wound in a plurality of successive winding turns with a lay angle close to 90°. Each winding has a cross sectional profile as described below and being substantially Z-shaped in very general terms. The profile has a trailing edge of one winding adapted to overlie and lock to the leading edge of an adjacent winding turn.

It will be understood that throughout this specification reference is made to an elongate band of material and it will be understood that such a term is to be broadly construed as encompassing any elongate structure having a preformed cross section that can be wound in a helical fashion around an underlying structure.

As can be seen in FIGS. 5 and 6, the profile of the cross section of the collapse resistant layer 404 has a substantially block-like nature with a main body section 621 interposed between a leading edge 622 and a trailing edge 623. The profile includes a leading edge hook 624 and a trailing edge hook 625. A leading edge valley 627 is disposed between the main body 621 and the hook 624. A trailing edge valley 627 is disposed between the main body 621 and the trailing edge hook 625. The profile of the band has a surface 628 that forms the inner surface of the tubular body formed when the band is helically wound and an outer surface 629 that forms the external surface of the helically wound layer. In this embodiment the outer surface 629 has a tapering section 630 that tapers towards the inner surface in a direction from the main body towards the trailing edge.

The width of the arm of the valley region and the arm of the hook region are sufficiently long to allow a certain desired amount of movement between adjacent windings in the axial direction so as to enable the flexible pipe body to flex. The profile of the band will however only allow a limited degree of movement in the axial direction. The layer 404 is constricted in the radial direction by its location between the supporting layer 402 and a radially outer layer described below.

Aptly, according to embodiments of the present invention, the band is a metal band having a preformed cross section. It will, however, be understood that the band may be manufactured from any suitable material that is capable of providing required physical characteristics for an application. The band may, for example, be carbon steel or stainless steel or an alloy of titanium, or a plastic or other non-metal material, or a composite structure with a metal or polymeric matrix.

The profile of the collapse resistant layer 404 has a fill factor of between 60 and 95%. More aptly, the fill factor is between 75 and 95%. In this respect, the fill factor is to be understood as the percentage of the cross sectional profile of a rectangular body that is filled with material. For example, as shown in FIG. 7a, a band having a rectangular profile of pitch 1x would have a 100% fill factor. If the band had grooves removed as shown in FIG. 7b, the fill factor would be less than 100%.

Collapse resistance of a flexible pipe layer will depend on various factors including the fill factor, total thickness of the layer in the radial direction, diameter of the circumference of the layer, and material strength (Young's modulus).

It is noted that the fill factor of known carcass layers such as that shown in FIG. 3 is around 55%.

Provided over the collapse resistant layer 404 is a fluid barrier layer 406, which is a layer of polymer material e.g. PE, PA11, PA12, PEX, PVDF or the like that is extruded over the collapse resistant layer to act as a seal against bore fluids from moving further into the pipe body. The barrier layer 406 may be of known materials and formed by known methods.

Any further layers to form the flexible pipe body, such as an optional pressure armour layer 408 as shown in FIG. 4 may be added to the pipe body as required for the particular application.

A method of manufacturing flexible pipe body according to an embodiment of the present invention will now be described with reference to FIG. 8. In a first step, a collapse resistant layer is formed by helically winding an elongate band of material having a substantially Z-shaped cross-sectional profile, the profile having substantially rectangular main body and a leading edge and a trailing edge, and a fill factor of between 60 and 95%. In a second step, a fluid retaining layer (barrier layer) is extruded over the collapse resistant layer.

In another embodiment, as a first step, an innermost polymer supporting layer is extruded onto a mandrel, and then the collapse resistant layer and barrier layer are provided over the supporting layer, as described above.

With the above described invention, the fill factor is much higher than currently known carcass layers for providing collapse resistance. Therefore, the collapse resistance of a flexible pipe body according to the invention will be much improved. It is noted that the collapse resistance is improved without having to introduce expensive new materials or redesign the pipe dimensions drastically. Therefore, the pipe bore will be wide enough to allow for greater flow rates.

Furthermore, since the collapse resistant layer is provided over a supporting layer, the supporting layer gives a generally smooth bore to the flexible pipe, yet with high collapse resistance previously reserved for rough bore pipes.

Also, since the collapse resistant layer gives a generally flat surface in profile (i.e. a none undulating, smooth surface) and the supporting layer also provides a generally flat surface in profile (i.e. a none undulating, smooth surface), then in use, vortices and vortex induced vibrations in the fluid flow should be prevented.

With the above described invention, production fluid from the bore will be able to permeate through the perforations and somewhat between the windings of the collapse resistant layer. The permeated fluid will then generally lie stagnantly in the areas of the perforations and windings, acting as an insulating layer between the bore and the radially outer layers of the flexible pipe body. Such an insulating layer will help to increase the temperature capability of the remaining layers of the flexible pipe. For example, a radially outer barrier layer that retains the bore fluid from the armour layers etc may use relatively cheaper materials or may be relatively thinner than known barrier layers. With the invention, the trapped static fluid will mean lower heat losses via convention compared to a standard carcass layer.

Various modifications to the detailed designs as described above are possible. For example, although the perforations have been described as mechanically pierced into the supporting layer, the perforations could be created as voids during extrusion via chemical reactions in the material of the supporting layer, or by other methods after extrusion whilst the material has not hardened, or later after the material has hardened. The perforations may be holes, slots, openings, apertures, etc of any suitable dimensions.

Although the collapse resistant layer has been described above as having a substantially Z-shaped cross sectional profile, alternatively, this layer may be formed from, for example, an elongate band of material having a different cross-sectional profile. For example, the profile may be nominally rectangular, C shaped (known as a “C clip”), Tee shaped, I shaped, K shaped, X shaped (all shapes of profiles of pressure armour layers known in the art), or any other suitable shape.

For example, as shown in FIG. 9, a pipe body may be formed of overlying generally cylindrical layers, including an innermost supporting layer 902 for forming a substantially smooth inner surface for facing the bore fluid in use. The supporting layer 902 has a plurality of perforations 903 extending therethrough from the bore facing surface to the radially outer surface.

Provided over the supporting layer 902 is a collapse resistant layer 904. The collapse resistant layer 904 is formed from two elongate metal bands that are helically wound in a plurality of successive winding turns with a lay angle close to 90°. Each winding has a cross sectional profile known as a C-clip profile (as known in the art as a profile for pressure armour layers). The profile of each band is substantially C-shaped, the two bands are arranged such that a first band overlies and locks against two windings of the adjacent second band.

Provided over the collapse resistant layer 904 may be a fluid barrier layer 906, to act as a seal against bore fluids from moving further into the pipe body. Any further layers to form the flexible pipe body, such as an optional pressure armour layer 908 as shown in FIG. 9 may be added to the pipe body as required for the particular application.

It will be clear to a person skilled in the art that features described in relation to any of the embodiments described above can be applicable interchangeably between the different embodiments. The embodiments described above are examples to illustrate various features of the invention.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A flexible pipe body, comprising:
a collapse resistant layer; and
a fluid retaining layer provided radially outwards of the collapse resistant layer,
wherein the collapse resistant layer comprises at least one elongate band of material having a cross-sectional profile having a fill factor of between 60 and 95%.

2. A flexible pipe body as claimed in claim 1, wherein the cross-sectional profile is substantially Z-shaped and has a substantially rectangular main body and a leading edge and a trailing edge.

3. A flexible pipe body as claimed in claim 2, wherein the elongate band is helically wound in a plurality of successive winding turns to form the collapse resistant layer, with the trailing edge of one winding adapted to overlie and lock to the leading edge of an adjacent winding turn.

4. A flexible pipe body as claimed in claim 3 wherein the cross-sectional profile includes a hooked region on the leading edge and a hooked region on the trailing edge.

5. A flexible pipe body as claimed in claim 1 further comprising a supporting layer provided radially inwards of the collapse resistant layer.

6. A flexible pipe body as claimed in claim 5 wherein the supporting layer or liner includes a plurality of perforations extending therethrough.

7. A flexible pipe body as claimed in claim 6 wherein the perforation are holes or slots or other such voids.

8. A flexible pipe body as claimed in claim 1 wherein the collapse resistant layer is shaped to allow the supporting layer to form a substantially smooth radially inner surface.

9. A flexible pipe body as claimed in claim 8 wherein the collapse resistant layer forms a substantially smooth radially inner surface.

10. A method of manufacturing a flexible pipe body, comprising:
providing a collapse resistant layer; and
providing a fluid retaining layer provided radially outwards of the collapse resistant layer;
wherein the collapse resistant layer comprises at least one elongate band of material having a cross-sectional profile having a fill factor of between 60 and 95%.

11. A method as claimed in claim 10, wherein the cross-sectional profile is substantially Z-shaped and has a substantially rectangular main body and a leading edge and a trailing edge.

12. A method as claimed in claim 11, further comprising helically winding the elongate band in a plurality of successive winding turns to form the collapse resistant layer, with the trailing edge of one winding adapted to overlie and lock to the leading edge of an adjacent winding turn.

13. A method as claimed in claim 12 wherein the cross-sectional profile includes a hooked region on the leading edge and a hooked region on the trailing edge.

14. A method as claimed in claim 10 further comprising providing a supporting layer radially inwards of the collapse resistant layer.

15. A method as claimed in claim 14 wherein the supporting layer includes a plurality of perforations extending therethrough.

16. A method as claimed in claim 14 wherein the collapse resistant layer is shaped to allow the supporting layer to form a substantially smooth radially inner surface.

17. A method as claimed in claim 16 wherein the collapse resistant layer forms a substantially smooth radially inner surface.

18.-19. (canceled)
